(19) United States
(12) Patent Application Publication
(10) Pub. No.: US 2014/0149789 A1
(43) Pub. Date: May 29, 2014

(54) DISPLAY APPARATUS AND SOFTWARE RECOVERY METHOD

(71) Applicant: Samsung Electronics Co., Ltd., Suwon-si (KR)

(72) Inventor: Hyung-Suk Kim, Suwon-si (KR)

(73) Assignee: Samsung Electronics Co., Ltd., Suwon-si (JP)

(21) Appl. No.: 14/036,224

(22) Filed: Sep. 25, 2013

(30) Foreign Application Priority Data
Nov. 23, 2012 (KR) 10-2012-0133512

(51) Int. Cl. G06F 11/14

(52) U.S. Cl. CPC G06F 11/1471
USPC 714/15

(57) ABSTRACT

Provided are an image processing apparatus and a software recovery method. The image processing apparatus, which is driven by software, includes: a storage which stores reference software; and a software recoverer which recovers current software with the reference software according to a predetermined command signal. Accordingly, recovering software, even in circumstances where a broadcasting signal may not be received, is provided.

### CROSS-REFERENCE TO RELATED APPLICATION

This application claims priority from Korean Patent Application No. 10-2012-0133512, filed on Nov. 23, 2012 in the Korean Intellectual Property Office, the disclosure of which is incorporated herein by reference in its entirety.

### BACKGROUND

1. Field

Apparatuses and methods consistent with exemplary embodiments relate to an image processing apparatus and a software recovery method, and more particularly, to an image processing display apparatus and a software recovery method which receives a broadcasting signal.

2. Description of the Related Art

A display apparatus which is capable of receiving a broadcasting signal may receive, from a content provider, various software that are broadcast together with the broadcasting signal. Such software may include key software for driving devices, and the display apparatus may maintain the latest version of software by upgrading the software to up-to-date broadcast software.

The software upgrade is accompanied by a rebooting operation by a bootstrap loader, and regardless of successful or unsuccessful upgrading, the display apparatus is rebooted after the upgrading.

As the software upgrade is conducted on the basis of the latest software that is received at the time of the upgrade, a user may not select software that he/she wants.

Also, only the broadcast software is subject to upgrade, and the display apparatus that is not capable of receiving a broadcasting signal may not recover its software even if the key software is not valid.

### SUMMARY

Accordingly, one or more exemplary embodiments provide a display apparatus and a software recovery method that may recover software even in the circumstances where a broadcasting signal may not be received.

Another exemplary embodiment is to provide a display apparatus and a software recovery method that may recover software by selecting a version of the software according to a user's preference.

Still another exemplary embodiment is to provide a display apparatus and a software recovery method that may selectively recover software if particular requirements are met.

According to an aspect of an exemplary embodiment, there is provided an image processing apparatus that is driven by software, the apparatus including: a storage which stores therein reference software; and a software recoverer which recovers current software with the reference software according to a predetermined command signal.

The command signal may be received from a content provider that transmits a broadcasting signal.

The image processing apparatus may further include a user interface (UI) generator which generates a graphic user interface (GUI) through which the predetermined command signal is input.

The GUI may include a user input window which is used to select software to be recovered and a recovery version.

The software recovery module may include: a flag setter which sets a recovery flag corresponding to the command signal; a flag checker which determines whether the recover flag is set; and a software recoverer which recovers current software with the reference software if it is determined that the recovery flag exists.

If it is determined that the recovery flag is not set, the software recoverer may determine a validity of the current software, and if the current software is determined to be invalid, may recover the current software with the reference software.

If the recovery of the software fails, the software recoverer may upgrade current software to broadcast software.

The reference software may be encoded and the software recoverer may determine a validity of the reference software and if the reference software is determined to be valid, the software recoverer may decode the reference software.

According to an aspect of another exemplary embodiment, there is provided a software recovery method of an image processing apparatus that is driven by software, the method including: storing reference software; receiving a predetermined command signal to recover current software; and recovering the current software with the stored reference software according to the received predetermined command signal.

The command signal may be received from a content provider which provides a broadcasting signal.

The method further includes generating a GUI to input the predetermined command signal.

The GUI may include a user input window which is used to select software to be recovered and a recovery version.

The recovering may include: setting a recovery flag corresponding to the predetermined command signal; determining whether the recovery flag is set; and recovering the current software with the reference software if it is determined that the recovery flag is set.

The method may further include: if it is determined that the recovery flag is not set, determining a validity of the current software; and recovering the current software with the reference software if the current software is invalid.

The method may further include upgrading the current software to broadcast software if the recovery of the software fails.

The storing may include determining a validity of the reference software, and the recovering may include decoding the reference software if the reference software is determined to be valid.

According to an aspect of another exemplary embodiment, there is provided a software recovery method of an image processing apparatus that is driven by software, the method including: obtaining a predetermined command signal to recover current software; and recovering the current software with pre-stored reference software according to the obtained predetermined command signal.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a control block diagram of a display apparatus according to an exemplary embodiment;

FIG. 2 is a control block diagram of a display apparatus according to another exemplary embodiment;

FIG. 3 is a control flowchart showing a software recovery method of the display apparatus in FIG. 2;

FIG. 4 is a detailed control flowchart showing the software recovery process in FIG. 3;

FIG. 5 is a control block diagram of a display apparatus according to another exemplary embodiment;

FIG. 6 is a control flowchart showing a software recovery method of the display apparatus in FIG. 5;

FIG. 7 illustrates a graphic user interface (GUI) which is generated by the display apparatus in FIG. 5; and

FIG. 8 illustrates another GUI which is generated by the display apparatus in FIG. 5.

### DETAILED DESCRIPTION OF EXEMPLARY EMBODIMENTS

Below, exemplary embodiments will be described in detail with reference to accompanying drawings so as to be easily realized by a person having ordinary knowledge in the art. Exemplary embodiments may be embodied in various forms without being limited to exemplary embodiments set forth herein. Descriptions of well-known parts are omitted for clarity, and like reference numerals refer to like elements throughout.

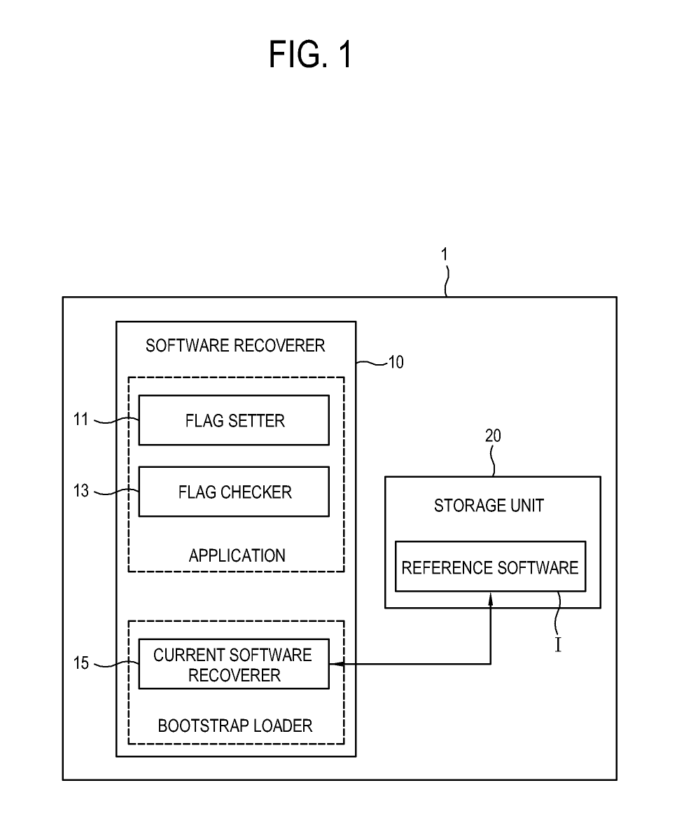

FIG. 1 is a control block diagram of a display apparatus 1 according to an exemplary embodiment. A display apparatus 1 according to the present exemplary embodiment includes any electronic device which may receive contents including a broadcasting signal through broadcasting or a network such as the Internet. The display apparatus 1 may include a television (TV), various computers such as a personal computer (PC), notebook computer, tablet PC, personal mobile handsets such as mobile phones that may display images, a large display apparatus installed, e.g., outside, etc. The display apparatus 1 includes main software for driving, which may be upgraded to a latest version. The main software, which may be referred to as a main image, may include an application, middleware, drivers, and an operating system (OS), and the main software may be upgraded at a time through a booting process. The main software may be stored in a non-volatile memory such as read only memory (ROM), flash memory, hard disc drive, etc. In addition to the main software for driving, the display apparatus 1 may include various application programs relating to contents. Upgrading refers to replacing current software with a new version, e.g., higher version. Recovery used herein refers to new storage of current software for any reason, e.g., if the current software is not valid. The software used for recovery may be the same version as the current software or different therefrom. Hereinafter, main software will be an example for explaining software recovery and upgrade according to the present exemplary embodiment.

The display apparatus 1 includes a software recoverer 10 (e.g., a recovery module) and a storage unit 20 (e.g., storage).

The storage unit 20 may include a non-volatile memory such as the ROM, flash memory, hard disc drive, which have been explained above. The storage unit 20 stores therein main software for driving the display apparatus 1, and reference software I for recovering the display apparatus 1.

The reference software I may be the same version as the current software or a lower or higher version than the current version, or a version whose safety or validity has been acknowledged through long-term valid usage thereof. The reference software I may be broadcast and stored together with a broadcasting signal, stored by a user, stored at the time when the display apparatus 1 is manufactured, etc. The reference software I may be upgraded to a new version at a user's option and may be fixed or restored to a particular software selected by a user.

The software recovery module 10 recovers the current software with the reference software I corresponding to a predetermined command signal. The command signal is a signal which is input to the display apparatus 1 to recover the current software. The command signal may include version information of the software to be recovered or type information of the software together with a control signal for recovery. The command signal may be input by a user or broadcast by a content provider.

As shown in FIG. 1, the software recovery module 10 includes a flag setting unit 11 (e.g., flag setter) which sets a recovery flag corresponding to the command signal, a flag checker 13 which checks whether the recovery flag is set, and a software recovery unit 15 (e.g., current software recoverer) which recovers the current software with the reference software I if it is determined that the recovery flag exists. The flag setting unit 11 which sets the recovery flag may include middleware or an application, and determines whether the recovery flag is set. If the recovery flag exists, a bootstrap loader which controls a booting process loads the reference software I. That is, the flag checker 13 and the software recovery unit 15 are provided by functionally distinguishing the operation of the bootstrap loader. As described above, if the recovery flag is set by the application, the display apparatus 1 enters the rebooting operation, and if the recovery flag is confirmed to exist, the bootstrap loader releases the recovery flag and recovers the software. After recovering the software is executed by using the reference software I, the display apparatus 1 is rebooted again.

If it is determined that the recovery flag is not set, the software recovery module 10 determines a validity of the current software. If the current software is not valid, the software recovery module 10 recovers the current software with the reference software I. That is, when the display apparatus 1 is rebooted by the bootstrap loader, the software recovery module 10 determines whether the software is valid. If the software is not valid or is not verified as suitable, the software is recovered with the reference software I to protect and prevent error of the display apparatus 1.

As described above, as the display apparatus 1 may recover its software with the reference software I stored in the storage unit 20, the display apparatus 1 may recover its software even if the display apparatus 1 may not receive a radio frequency (RF) signal or a communication sate is not good. That is, even if there is a serious problem in the software, the display apparatus 1 may recover its software to a desired version of software at any time.

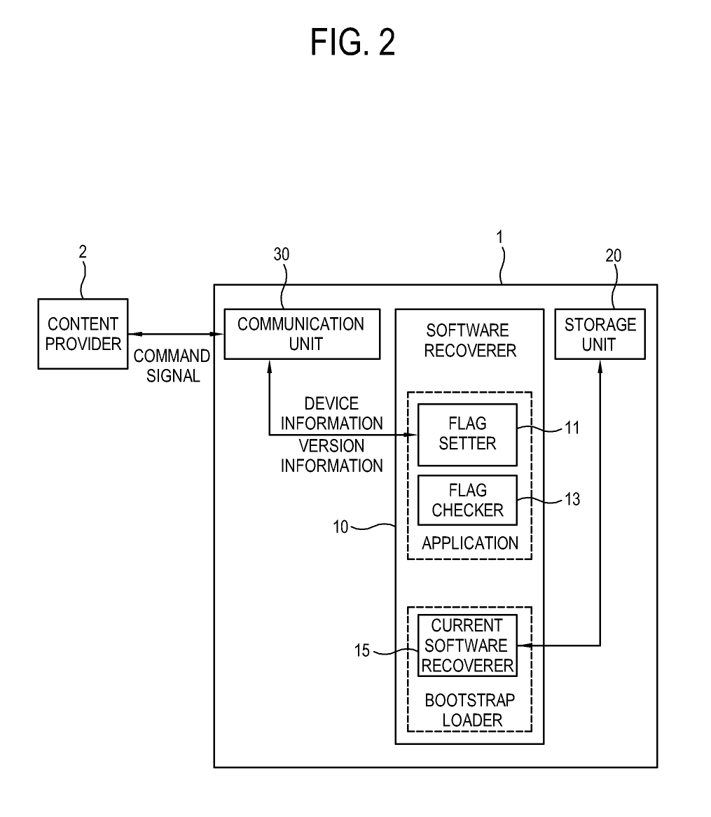

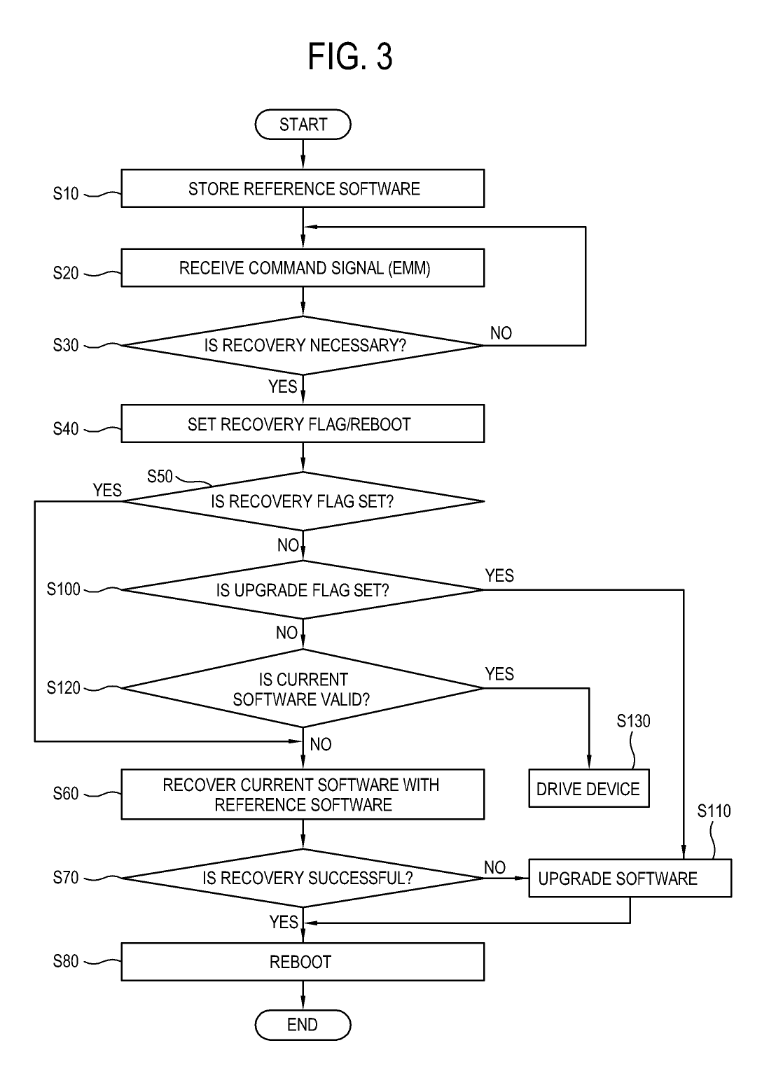

FIG. 2 is a control block diagram of a display apparatus 1 according to another exemplary embodiment. FIG. 3 is a control flowchart showing a software recovery method of the display apparatus 1 in FIG. 2.

The display apparatus 1 according to the present exemplary embodiment further includes a communication unit 30 (e.g., communicator) which communicates with a content provider 2, and the communication unit 30 receives a command signal from the content provider 2. The content provider 2 may include a broadcasting station which transmits a broadcasting signal. The command signal transmitted by the content provider 2 may include entitlement management message (EMM) data. The EMM data is a message transmitted to a signal receiver such as the display apparatus 1, and may include content of a particular right and ZIP code. Furthermore, according to the present exemplary embodiment, the EMM data may include at least one of device information and recovery version information of a recovered target.

For example, the content provider 2 may transmit a recovery command to the display apparatus 1 located in a particular area only or transmit a recovery command signal to the display apparatus 1 with particular specifications. If there is any problem in, or error in validation of, a particular version of software, the content provider 2 may transmit a command signal to the display apparatus 1 which has downloaded the problematic software. The software recovery module 10 may recover the current software with the reference software I according to the command signal transmitted by the content provider 2.

The command signal may include a signal to modify the reference software I, in which case the software recovery module 10 may upgrade the reference software I stored in the storage unit 20 to a new version according to the command signal. Referring to FIG. 3, the software recovery and upgrading method according to the present exemplary embodiment will be described.

The display apparatus 1 stores the reference software I in the storage unit 20 (operation S10). As described above, the reference software I is stored through any of various methods, and may be upgraded to a new version at a user's option. The reference software I may also be automatically set to be upgraded if certain requirements are met, regardless of a user's option. The reference software I may be encoded and may be stored together with, or by using, identifiers which identify each device such as a central processing unit (CPU) identifier (ID), a media access control (MAC address), a security key, etc. The reference software I may be stored in a kernel of a CPU according to a predetermined security policy so as to be loaded only to a particular display apparatus which complies with the security policy.

If the content provider 2 transmits the EMM data for the software recovery, the command signal is received through the communication unit 30 (operation S20).

The flag setting unit 11 analyzes the command signal and determines whether the software recovery is to be performed (e.g., necessary) (operation S30). The flag setting unit 11 identifies device information and version information included in the command signal, and software to be recovered, etc., to determine whether the recovery flag setting is to be performed.

If it is determined that the software recovery is not to be performed, the recovery process goes back to the operation of receiving the command signal.

If it is determined that the software recovery is to be performed, the flag setting unit 11 sets the recovery flag, and causes the display apparatus to be rebooted by the bootstrap loader (operation S40).

If the display apparatus 1 enters the rebooting operation, the flag checker 13 which is implemented as a bootstrap loader determines whether the recovery flag is set (operation S50).

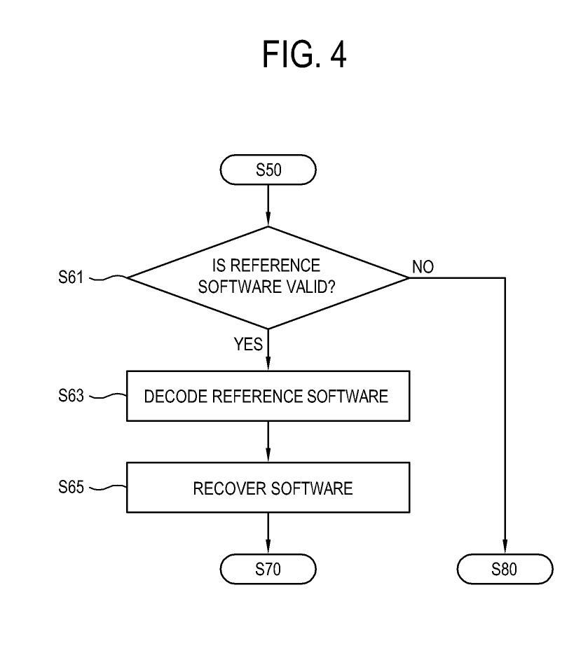

If it is determined that the recovery flag is set, the software recovery unit 15 recovers the current software with the reference software I stored in the storage unit 20 (operation S60). FIG. 4 is a detailed control flowchart of the software recovery process (operation S60) in FIG. 3. As shown therein, the software recovery unit 15 determines validation of the reference software I stored in the storage unit 20 (operation S61). This is to determine whether the reference software I is normal, i.e., whether the software image is not broken, and includes, e.g., determination on check-sum or program length. If it is determined that the reference software I is valid, the software recovery unit 15 decodes the reference software I (operation S63), and recovers the software (operation S65).

Referring back to FIG. 3, if the software is recovered by the software recovery unit 15, the software recovery module 10 checks whether the recovery has been successful (operation S70).

If the recovery has been successful, the display apparatus 1 enters the rebooting process (operation S80).

If the recovery has failed, the display apparatus 1 enters the software upgrading operation (operation S110).

Returning to the operation S50, if it is determined that the recovery flag is not set, the display apparatus 1 may determine whether an upgrade flag is set (operation S100). As the rebooting process is performed by the bootstrap loader for software recovery and upgrade, the bootstrap loader may check the upgrading/non-upgrading while performing the recovery process.

If it is determined that the upgrade flag is set, the software upgrading is performed (operation S110).

After the software upgrading is successfully performed, the display apparatus 1 completes its upgrading through the rebooting operation (operation S80).

If the upgrade flag is not set, the bootstrap loader determines whether the current software is valid (operation S120).

As described herein, a software checking process is performed in the course of the booting process. If it is determined that the software has a problem and thus is not valid, the software is recovered with the reference software I and loaded as new software (operation S60). That is, to prevent damage to, or non-performance of, operation of the display apparatus 1, the display apparatus 1 recovers the software with the reference software I.

If the software is determined to be normal, the display apparatus 1 is normally driven (operation S130).

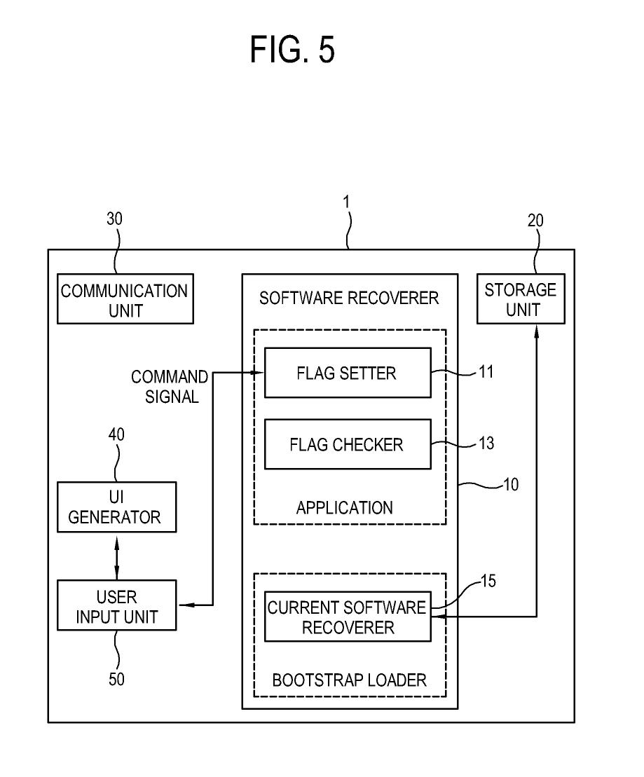

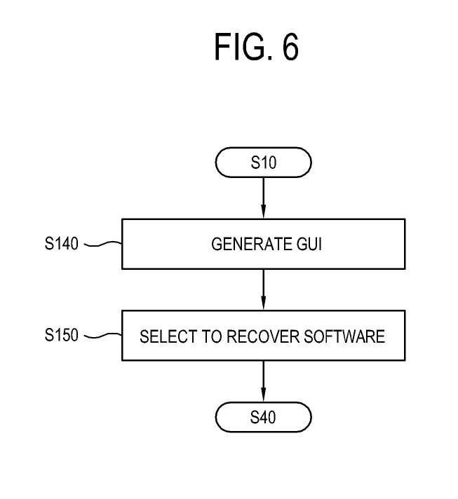

FIG. 5 is a control block diagram of a display apparatus 1 according to another exemplary embodiment. FIG. 6 is a control flowchart showing a software recovery method of the display apparatus 1 in FIG. 5.

The display apparatus according to the present exemplary embodiment further includes a user interface (UI) generator 40 which generates a graphic user interface (GUI) for inputting a command signal; and a user input unit 50 (e.g., user inputter) to generate various control signals by a user.

If a user finds that the current software is not consistent with his/her preference or the current software generates frequent errors, he/she may recover the software to desired software at a desired timing. For example, a user may recover the software to an older version after using the latest version of the software, or upon occurrence of error in the software in use, he/she may recover the current software with the reference software I stored in the storage unit 20 through the UI generator 40. According to the present exemplary embodiment, a user may recover the software to a desired version even if the display apparatus 1 may not receive a broadcasting signal.

As shown in FIG. 6, if the reference software I is stored in the storage unit 20, a user may input a command to generate a GUI through the user input unit 50. Then, the UI generator 40 generates the GUI to recover the software (operation S140).

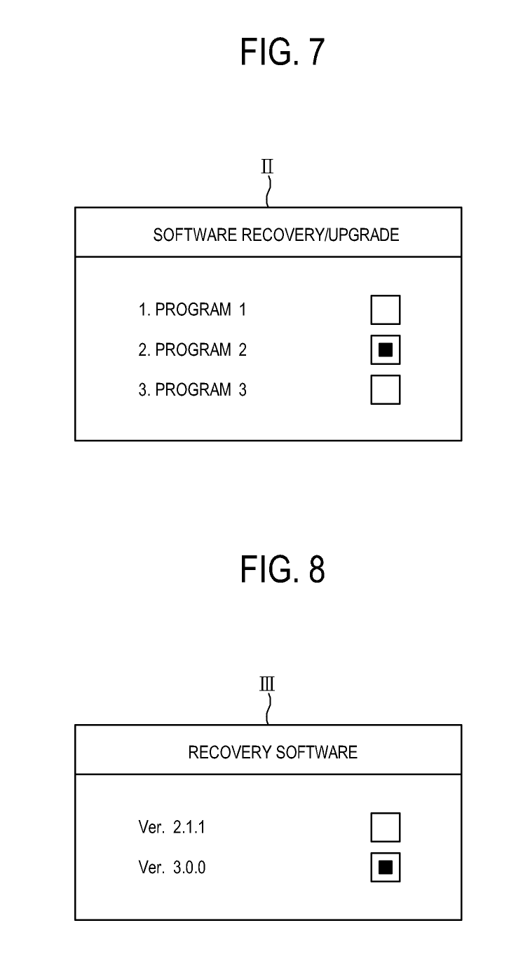

FIGS. 7 and 8 illustrate a GUI generated by the UI generator 40 according to the present exemplary embodiment. FIG. 7 illustrates a program selection window II that is provided for a user to select software, e.g., a program to be recovered or upgraded. As described above, recovery and upgrade of software is accompanied by a rebooting process by a bootstrap loader, and for a user's recognition, selection of recovery and upgrade may be generated as a GUI. The UI generator 40 may support a user's selection by displaying software to be recovered.

If a user selects one of a plurality of programs, the UI generator 40 may generate a version selection window III to select a version as shown in FIG. 8. The version selection window III guides a user a version stored in the storage unit 20 with respect to the program selected by a user. A user may recover the software by selecting a desired version.

The UI generator 40 may generate a UI for a user to select and store the reference software I, and if a new version of software is provided by the content provider 2, the UI generator 40 may generate a selection window to select the new version of software as the reference software I. The UI generator 40 may generate a selection window to delete or remove the set reference software I.

If a user selects the recovery of software (operation S150), the flag setting unit 11 sets the recovery flag as shown in operation S40 of FIG. 3 and the display apparatus 1 enters the rebooting operation. Thereafter, the software may be recovered through the same or similar processes.

As described above, one or more exemplary embodiments recover software with the reference software I stored in the storage unit 20 at a user's option or at the instruction of the content provider 2. In this case, even if the display apparatus 1 may not receive a broadcasting signal, the software may be recovered to a desired version, or to an older version or stable version rather than the latest version.

As described above, a display apparatus 1 and a software recovery method according to one or more exemplary embodiments may recover software even in the circumstances where a broadcasting signal may not be received (e.g., when a broadcasting signal receiving capability of the display apparatus 1 is inoperable, malfunctioning, etc.).

Further, a display apparatus 1 and a software recovery method according to another exemplary embodiment may select a desired version of software according to a user's preference and recover current software to the desired version.

Further, a display apparatus 1 and a software recovery method according to another exemplary embodiment may selectively recover software when particular requirements are met.

While exemplary embodiments have been described above with reference to a display apparatus 1, it is understood that one or more other exemplary embodiments are not limited thereto. For example, one or more other exemplary embodiments may include any image processing apparatus, including an image processing apparatus that is connectable to an external display device.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more units or elements of the above-described apparatuses 1 can include circuitry, a processor, a microprocessor, etc., and may execute a computer program stored in a computer-readable medium.

Although a few exemplary embodiments have been shown and described, it will be appreciated by those skilled in the art that changes may be made in these exemplary embodiments without departing from the principles and spirit of the present inventive concept, the scope of which is defined in the appended claims and their equivalents.

What is claimed is:

1. An image processing apparatus which is driven by software, the image processing apparatus comprising:
a storage which stores reference software; and
a software recoverer which recovers current software with the stored reference software according to a predetermined command signal.

2. The image processing apparatus according to claim 1, wherein the predetermined command signal is received from a content provider that transmits a broadcasting signal.

3. The image processing apparatus according to claim 1, further comprising a user interface (UI) generator which generates a graphic user interface (GUI) through which the predetermined command signal is input.

4. The image processing apparatus according to claim 3, wherein the GUI comprises a user input window through which the predetermined command signal is received to select software to be recovered and a recovery version.

5. The image processing apparatus according to claim 1, wherein the software recoverer comprises:
a flag setter which sets a recovery flag corresponding to the predetermined command signal;
a flag checker which determines whether the recovery flag is set; and
a current software recoverer which recovers the current software with the stored reference software in response to the flag checker determining that the recovery flag is set.

6. The image processing apparatus according to claim 5, wherein, in response to the flag checker determining that the recovery flag is not set, the software recoverer determines a validity of the current software, and in response to the stored software recoverer determining that the current software is invalid, the software recoverer recovers the current software with the reference software.

7. The image processing apparatus according to claim 1, wherein, in response to the recovery of the current software failing, the software recoverer upgrades the current software to broadcast software.

8. The image processing apparatus according to claim 1, wherein the reference software is encoded and the software recoverer determines a validity of the stored reference software, and in response to determining that the reference software is valid, the software recoverer decodes the stored reference software.

9. The image processing apparatus according to claim 1, wherein the image processing apparatus is a display apparatus.

10. The image processing apparatus according to claim 1, further comprising a communicator which receives a broadcasting signal,
wherein the software recoverer recovers the current software with the stored reference software when the communicator is unable to receive the broadcasting signal.

11. A software recovery method of an image processing apparatus that is driven by software, the method comprising:
storing reference software;
receiving a predetermined command signal to recover current software; and
recovering the current software with the stored reference software according to the received predetermined command signal.

12. The method according to claim 11, wherein the predetermined command signal is received from a content provider that transmits a broadcasting signal.

13. The method according to claim 11, further comprising generating a GUI through which the predetermined command signal is input.

14. The method according to claim 13, wherein the GUI comprises a user input window through which the predetermined command is received to select software to be recovered and a recovery version.

15. The method according to claim 11, wherein the recovering comprises:
setting a recovery flag corresponding to the predetermined command signal;
determining whether the recovery flag is set; and
recovering the current software with the stored reference software in response to determining that the recovery flag is set.

16. The method according to claim 15, further comprising:
in response to determining that the recovery flag is not set, determining a validity of the current software; and
recovering the current software with the stored reference software in response to determining that the current software is invalid.

17. The method according to claim 11, further comprising upgrading the current software to broadcast software in response to the recovery of the current software failing.

18. The method according to claim 11, wherein:
the storing comprises determining a validity of the stored reference software; and
the recovering comprises decoding the stored reference software in response to determining that the stored reference software is valid.

19. A software recovery method of an image processing apparatus that is driven by software, the method comprising:
obtaining a predetermined command signal to recover current software; and
recovering the current software with pre-stored reference software according to the obtained predetermined command signal.

20. The method according to claim 19, wherein:
the image processing apparatus comprises a communicator which receives a broadcasting signal; and
the recovering is performed when the communicator is unable to receive the broadcasting signal.

21. A computer readable recording medium having recorded thereon a program executable by a computer for performing the method of claim 11.

22. A computer readable recording medium having recorded thereon a program executable by a computer for performing the method of claim 19.
